(19) United States
(12) Patent Application Publication
(10) Pub. No.: US 2013/0032773 A1
(43) Pub. Date: Feb. 7, 2013

(54) SAFETY BARRIER

(71) Applicant: Gaetan JETTE, Mascouche (CA)

(72) Inventor: Gaetan JETTE, Mascouche (CA)

(73) Assignee: 9172-9863 QUÉBEC INC., Terrebonne (CA)

(21) Appl. No.: 13/558,884

(22) Filed: Jul. 26, 2012

Related U.S. Application Data
(60) Provisional application No. 61/513,898, filed on Aug. 1, 2011.

(51) Int. Cl. E04H 17/20; B23P 11/00

(52) U.S. Cl. 256/65.02; 256/59; 29/428

(57) ABSTRACT

The safety barrier is provided for delimiting two adjacent areas from one another on an open floor surface. The safety barrier includes a plurality of spaced-apart posts. Each post has a bottom portion releasibly connectable to the floor surface and has a vertically-extending upper portion. The safety barrier also includes at least one interconnecting segment located above the floor surface and transversally extending across a corresponding intervening space between each two successive ones of the spaced-apart posts. In use, when one of the posts and/or one of the interconnecting segments is/are subjected to an impact with a moving object, the connection between the impacted post and the floor surface and/or the connection between the impacted post and any interconnecting segment connected thereto and/or the connection between the impacted interconnecting segment and any one of the posts to which it is connected can be temporally discontinued.

### CROSS-REFERENCE TO RELATED APPLICATION

The present application claims the benefits of U.S. provisional patent application No. 61/513,898 filed 1 Aug. 2011, the contents of which are hereby incorporated by reference.

### TECHNICAL FIELD

The technical field relates generally to safety barriers for delimiting two adjacent areas from one another in an open space.

### BACKGROUND

Many industrial and commercial sites have vehicles circulating therein. For instance, forklifts and/or other vehicles are often circulating in plants and warehouses. Loading docks can be particularly busy in terms of vehicle movements. There is thus often a need for delimiting an area where the moving vehicles are present from an adjacent area located in the same open space, for instance a pedestrian walkway or another kind of area where vehicles should not go. Areas to delimit from one another do not always involve vehicles. For instance, it may be desirable to delimit an area around a machine or a storage area from the adjacent areas.

One approach used in the past is to delimit the areas using lines painted on the floor surface. Such approach, although simple and relatively inexpensive, may not always be easy to see in some circumstances, for instance by a driver of a forklift moving a large item. A distracted pedestrian may also easily step out of the walkway by mistake. Another problem is that painted lines may erase with time.

Another approach is the use of a fixed barrier provided to physically separate the areas from one another. The fixed barrier is rigidly anchored to the floor surface or has a bottom portion inserted in holes made into the floor surface. It prevents pedestrians from easily stepping out of the walkway and into an off-limit area. On the other hand, they are difficult to relocate and/or they can be difficult to temporarily remove. Also, in case of an impact between a moving object and a section of a fixed barrier, the resulting damages to goods/products, to the moving vehicles or to the barrier section can be costly. Also, a fixed barrier can become a pinch point for pedestrians and workers that come from the warehouse with circulating moving vehicles such as lift trucks.

Another approach is to use barriers with posts or posts having heavy bases resting by gravity only on the floor surface. One drawback of such approach is that the bases must often be relatively large and heavy to provide the desired stability. Large bases can become obstacles for both pedestrians and vehicles.

Clearly, room for improvements still exists in this area.

### SUMMARY

In one aspect, there is provided a safety barrier for delimiting two adjacent areas from one another on an open floor surface. The safety barrier includes a plurality of spaced-apart posts. Each post has a bottom portion releasibly connectable to the floor surface and has a vertically-extending upper portion. The safety barrier also includes at least one interconnecting segment located above the floor surface and transversally extending across a corresponding intervening space between each two successive ones of the spaced-apart posts. Each interconnecting segment has opposed ends connected to the upper portion of the two corresponding posts. In use, when one of the posts and/or one of the interconnecting segments is/are subjected to an impact with a moving object, the connection between the impacted post and the floor surface and/or the connection between the impacted post and any interconnecting segment connected thereto and/or the connection between the impacted interconnecting segment and any one of the posts to which it is connected can be temporally discontinued.

In another aspect, there is provided a method of delimiting two adjacent areas from one another on an open floor surface, the method including: releasibly connecting a plurality of spaced-apart posts to the floor surface, each post having a bottom portion to the floor surface and having a vertically-extending upper portion; providing at least one interconnecting segment located above the floor surface and transversally extending across a corresponding intervening space between each two successive ones of the plurality of spaced-apart posts, each interconnecting segment having opposed ends connected to the upper portion of the two corresponding posts; and allowing one of the posts and/or one of the ends of the interconnecting segments to be removably discontinued when subjected to an impact with a moving object.

Further details on these aspects as well as other aspects of the proposed concept will be apparent from the following detailed description and the appended figures.

### BRIEF DESCRIPTION OF THE FIGURES

FIG. 1 is a semi-schematic view of an example of one of the posts of a safety barrier as suggested herein;

FIG. 2 is a semi-schematic view of an example of a safety barrier where the interconnecting segments include chains;

FIG. 3 is view similar to FIG. 2 but illustrates another example of a safety barrier where the interconnecting segments include screen-like panels;

FIGS. 4 to 12 are views similar to FIG. 1 but illustrate other examples of posts;

FIG. 13 is an isometric view illustrating an example of an interconnecting segment having a releasibly connectable with a post;

FIG. 14 is a view similar to FIG. 2 but illustrates an example of a safety barrier including an alarm system; and

FIGS. 15 to 19 are semi-schematic views illustrating examples of optical sensor arrangements provided at locations where a roadway and a pedestrian walkway overlap with one another.

### DETAILED DESCRIPTION

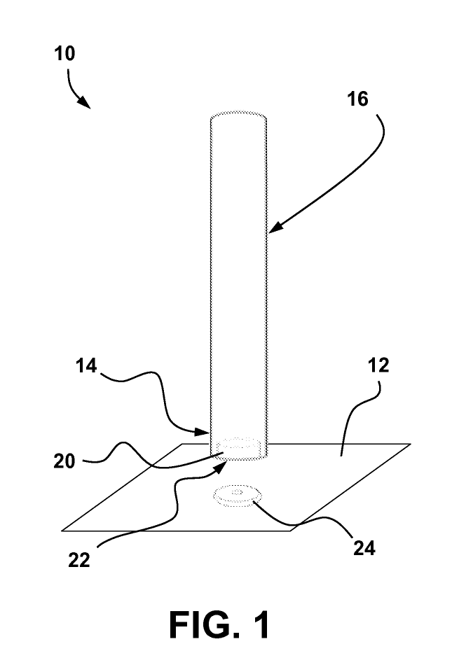

FIG. 1 is a semi-schematic view of an example of one of the posts 10 of a safety barrier as suggested herein. This safety barrier is for use on an open floor surface 12 to delimit two adjacent areas from one another, for instance at a plant. The floor surface 12 can be located in places such as warehouses or large shopping stores, to name just a few. It can be an indoor floor surface or an outdoor floor surface.

The post 10 has a bottom portion 14 releasibly connectable to the floor surface 12. It also has a vertically-extending upper portion 16 that is generally located above the bottom portion 14. The outer surface of the post 10 can have a bright color, such as yellow or orange, and also include one or more reflective strips and/or bands of contrasting colors for maximizing its visibility.

In the example illustrated in FIG. 1, the post 10 has a circular cross section and its bottom portion 14 includes a permanent magnet 20 located in a recess 22 at the bottom end of the post 10. This magnet 20 is configured and disposed to fit over a plate 24 made of a magnetic material, for instance a ferromagnetic material, with which the magnet 20 can be magnetically coupled. FIG. 1 shows the parts being unconnected.

The plate 24 can be omitted if the post 10 is to be installed over a metallic surface to which the magnet 20 can adhere. For instance, the floor surface 12 could be made of steel plates or gratings. It is further possible to have steel strips or the like in or on the floor surface 12 with which the magnet 20 can be magnetically coupled.

In the example of FIG. 1, the plate 24 is bolted, screwed, glued, welded, embedded or otherwise rigidly attached to the floor surface 12. It extends slightly above the floor surface 12 and has a chamfered periphery so that it does not significantly impede the pedestrian and/or the vehicle traffic. In use, the post 10 is put over the plate 24 and the magnetic force from the magnet 20 holds the post 10 in place. This provides a “releasable” connection. A releasable connection is defined herein as connection that can be temporally discontinued without breaking the posts 10 in case of an impact with a moving object, for instance a significant impact with a forklift or an item carried by it. This impact can be the result of an error from the driver, for instance. Generally, impacts in such contexts occur at relatively low speeds. An impact becomes significant if it is more than a mere contact that does not move any part of the safety barrier from its original position. Of course, a major collision, involving for instance a vehicle hitting the safety barrier at high speed and/or that goes off course over more than a relatively short distance, can break or otherwise damage some parts of the safety barrier. The term “impact” used herein means a significant impact that is not a major collision. In that context, the safety barrier is said to be “impactable”.

In another design for heavy duty purposes, a strong magnet can be used, as well as solid post and strong connecting elements. This combination can sustain greater impacts; one post may detach but interconnecting segments and the surrounding posts can stand to keep some integrity to the safety barrier and help absorb a high speed impact or decelerate a moving vehicle.

Variants of the plate 24 are also possible. For instance, the plate 24 can be provided in a shallow recess in the floor surface 12. Also, it should be noted that the relative position of the magnet 20 and the plate 24 can be inverted, meaning that the magnet 20 can be attached to the floor surface 12 while the bottom portion 14 of the post 10 includes a corresponding element with which the magnet can interact. It is also possible to provide opposite magnets on the floor surface 12 and the bottom end of the post 10.

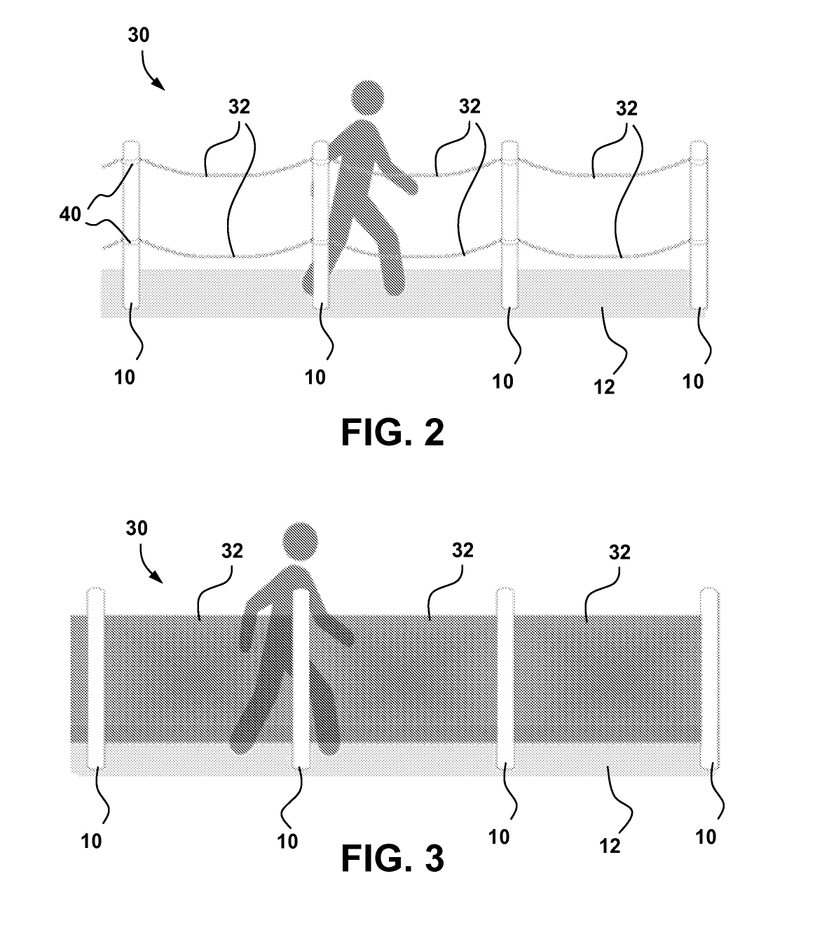

FIG. 2 is a semi-schematic view of an example of a safety barrier 30. The safety barrier 30 includes two or more posts 10 that are linked together using at least one interconnecting segment 32 located above the floor surface 12 and transversally extending across a corresponding intervening space between each two successive ones of the plurality of spaced-apart posts 10. In its simplest form, the safety barrier 30 can include only two posts 10 and one interconnecting segment 32. In FIG. 2, more than two posts 10 are provided and the interconnecting segments 32 include chains loosely extending between the posts 10. Two lengths of chain are provided between each post 10. Variants are also possible.

Each interconnecting segment 32 has opposed ends connected to the upper portion 16 of the two corresponding posts 10. Depending on the needs, these connections can be releasable or not.

Various kinds of releasable connections can be used. For instance, the ends of the interconnecting segments 32 can be magnetically attached the posts 10 using individual permanent magnets or pairs of permanent magnets. Another possible example is the use of a frangible connecting element that can be easily replaced, such as a plastic tie wrap or the like.

If desired, only some of the ends of the interconnecting segments 32 can be provided with releasable connections, the other ends having non-releasable connections with the posts 10. A further possible possibility is to have only non-releasable connections. A non-releasable connection is defined herein as connection that is either non-removable or only removable by the action of a person, for instance by pressing the lever of a carabiner or using a tool to remove a bolt or a screw. Another example is to provide an uninterrupted chain between more than two posts 10, in which case the connection between the interconnecting segments 32 of the posts 10 at the center would be non-releasable. Other examples can be devised as well.

In FIG. 2, the chain segments are connected to the posts 10 using collars 40 mounted over the surface of the posts 10.

FIG. 3 is view similar to FIG. 2 but illustrates another example of a safety barrier 30 where the interconnecting segments 32 include screen-like panels instead of chains. The screen-like panels 32 can be provided individually, with or without a releasable connection with the posts 10, or be part of an uninterrupted stretch.

In use, when one of the posts 10 and/or one of the interconnecting segments 32 is/are subjected to an impact with a moving object, the connection between the impacted post 10 and the floor surface 12 and/or the connection between the impacted post 10 and any interconnecting segment 32 connected thereto and/or the connection between the impacted interconnecting segment 32 and any one of the posts 10 to which it is connected can be temporally discontinued, meaning that the parts detach without breaking. The parts can then be reattached or, if frangible elements were used, new frangible elements are installed.

As can be appreciated, the safety barrier 30 provides various advantages. It provides a much better visual indication compared to pained lines. It also provides a physical separation that can withstand an impact with a moving object without breaking The safety barrier 30 can then be put back where it was after the incident. The safety barrier 30 is easy to remove when needed, such as when an oversized object must be moved and more room is needed to get it through. Changing the configuration and/or the location of the areas is also much easier to do compare to an arrangement involving railings rigidly attached to the floor surface 12. Plates 24 can even be left where they are when the safety barrier 30 is relocated, if desired.

If desired, the safety barrier 30 can be provided as a short-term temporary barrier. For instance, it can be used to indicate that an area is closed for maintenance or the like. In its simplest form, the safety barrier 30 can include only two posts 10 with one interconnecting segment 32. Each post 10 includes a magnet 20 magnetically coupled to a steel plate or grating already present on the floor surface 12 around the area to be temporarily closed.

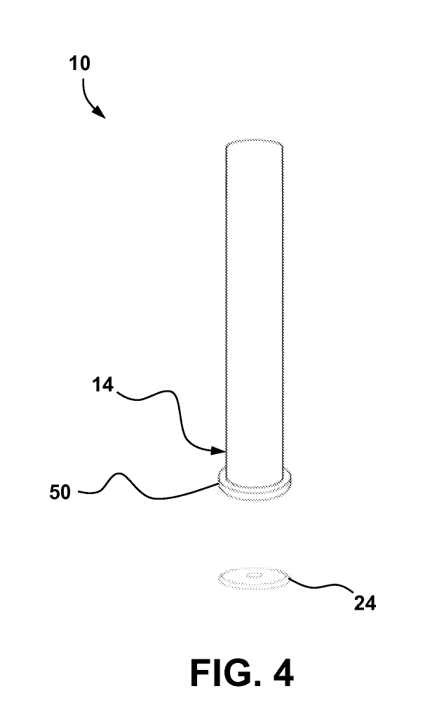

FIGS. 4 to 12 are views similar to FIG. 1 but illustrate other examples of posts 10.

In FIG. 4, the bottom portion of the post 10 includes the magnet 20 but the outer periphery of the bottom portion 14 includes a protective outer ring 50 that is made for instance of polymeric material such as rubber or another relatively soft material. The protective outer ring 50 protects against pinching the skin of a user mishandling the post 10, for instance if the user leaves a finger near the outer periphery of the bottom portion 14 of the post 10 as the magnet 20 and the plate 24 are brought into engagement with one another. The protective outer ring 50 allows the post to have at its bottom portion a strong magnet to offer greater resistance to impact by moving vehicles.

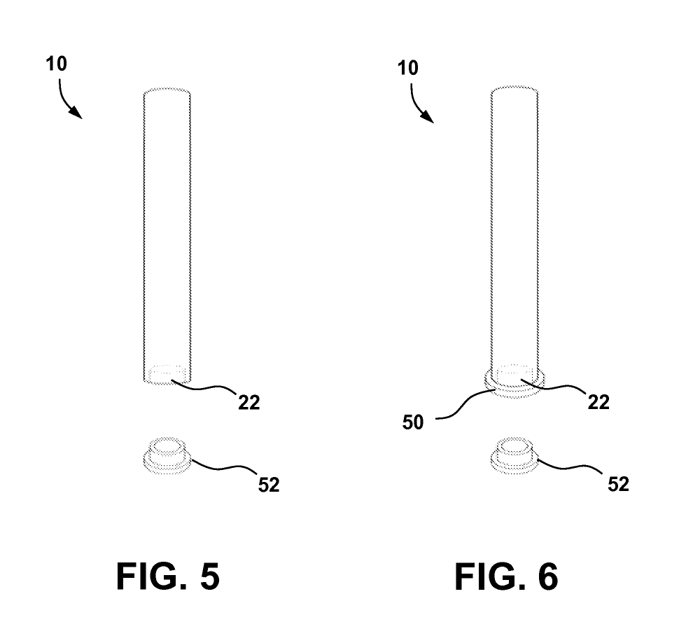

In FIG. 5, the connection between the post 10 and the floor surface 12 is provided by a removable snap-fit engagement between the recess 22 in the bottom portion 14 of the post 10 and a corresponding rigid floor surface member 52. FIG. 6 shows an arrangement similar to FIG. 5 but having the protective outer ring 50.

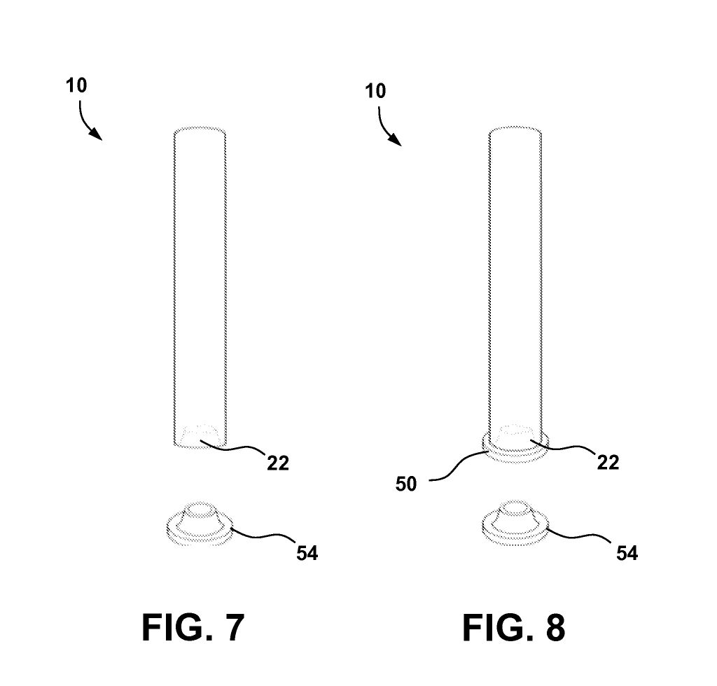

FIGS. 7 and 8 illustrate arrangement similar to FIGS. 5 and 6, respectively. However, they include a floor surface member 54 that is made of a relatively soft material, for instance rubber.

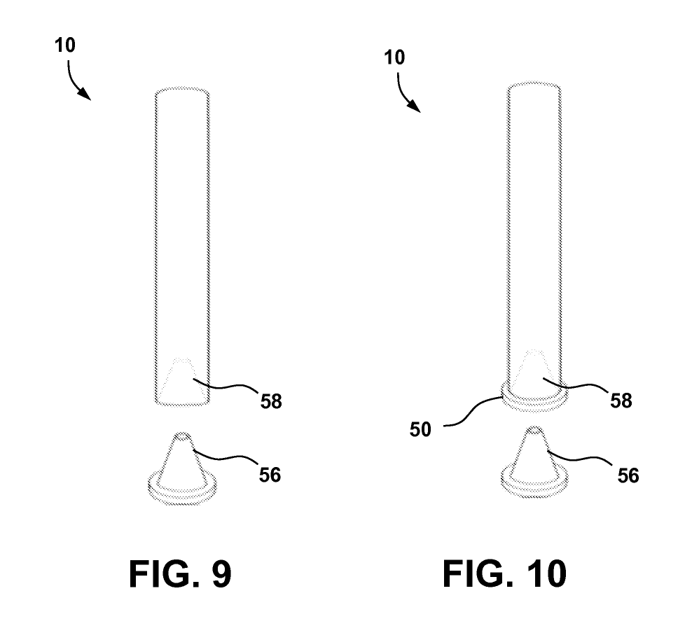

In FIG. 9, the connection between the post 10 and the floor surface 12 involves an arrangement where a holding force is created by suction. At least one among the floor surface member 56 and the receptacle 58 inside the bottom portion 14 of the post 10 is made of a relatively soft material, such as rubber, designed to expel air when the post 10 is inserted thereon and to create a resulting vacuum holding the post 10 in place. FIG. 10 shows an arrangement similar to FIG. 9 but having the protective outer ring 50.

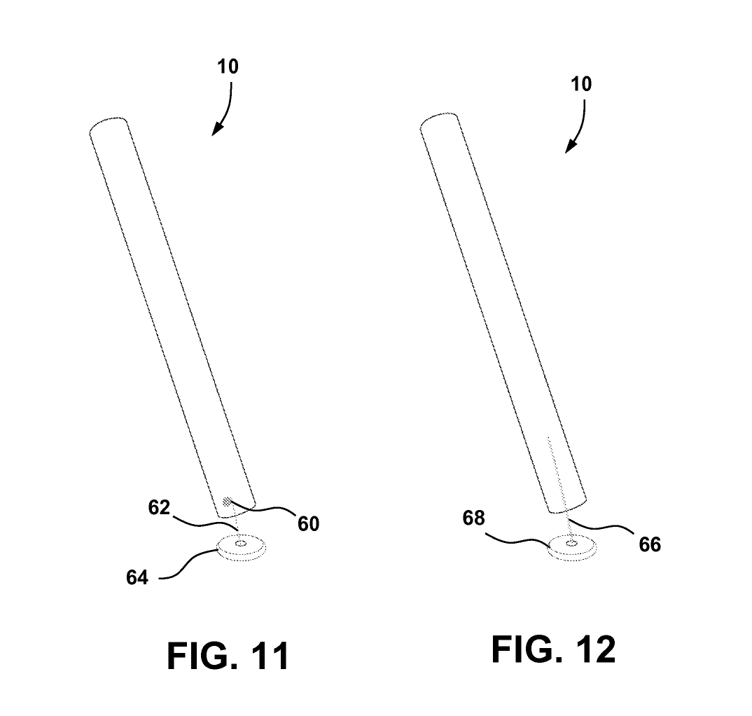

In FIG. 11, the connection between the post 10 and the floor surface 12 involves an arrangement having a recoil device 60 located inside the post 10. The recoil device 60 pulls back a wire or a rope 62 having its free end attached to a plate 64, itself rigidly anchored to the floor surface 12. The free end of the wire or rope 62 can be removably attached to the plate 64 so that the post 10 can be easily removed when needed.

In FIG. 12, the connection between the post 10 and the floor surface 12 involves an arrangement having an elastic band 66. The elastic band 66 has a top end attached inside the post 10 and a bottom end attached to a plate 68, itself rigidly anchored to the floor surface 12. The bottom end of the elastic band 66 can be removably attached to the plate 68 so that the post 10 can be easily removed when needed.

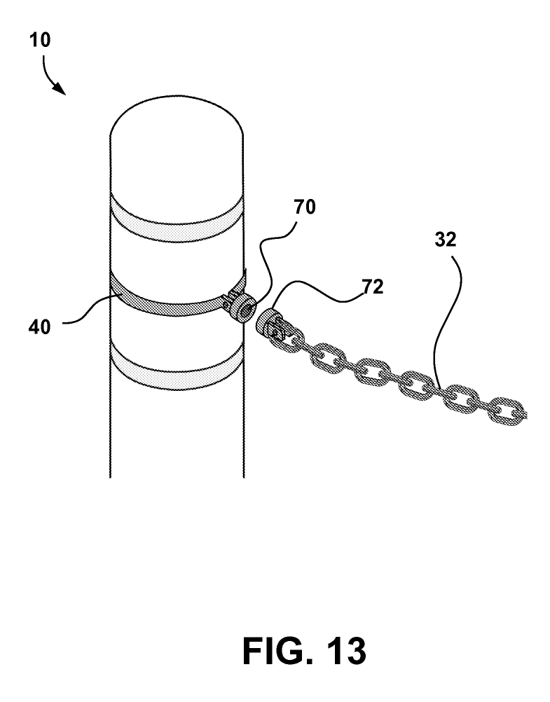

FIG. 13 is an isometric view illustrating an example of an interconnecting segment 32 having a releasibly connectable with a post 10. The collar 40 holds a magnet 70 which interacts with a part 72 made of a magnetic material and that is attached to the end of the interconnecting segment 32.

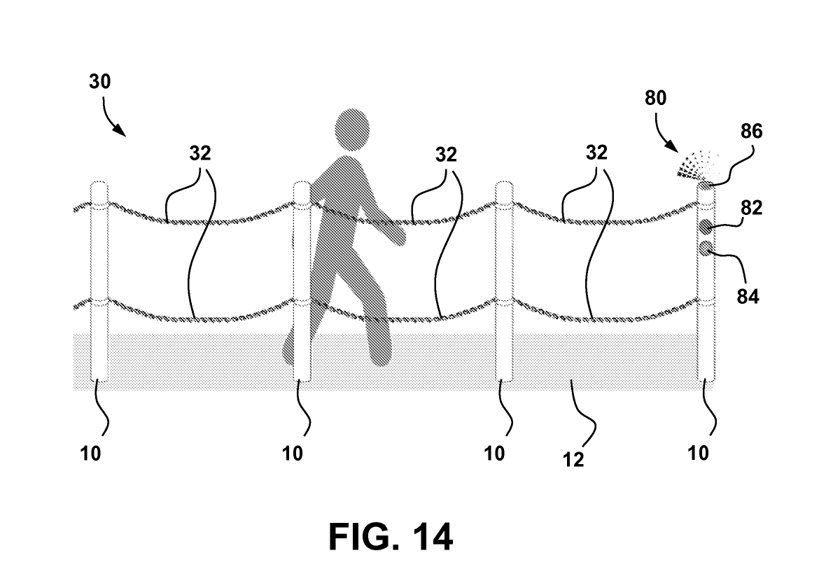

FIG. 14 is a view similar to FIG. 2 but illustrates an example of the safety barrier 30 in which an alarm system 80 is provided. The alarm system 80 detects if one or more ends of the interconnecting segments 32 are detached and/or detects if one or more posts 10 are moved out of registry with the corresponding plates 24. Upon detecting such event, the alarm system 80 can trigger a visual and/or audible alarm.

In the example shown in FIG. 14, one of the posts 10 includes lights indicating the status of the alarm system 80. It has a green light 82 and a red light 84. The green light 82 indicates that the safety barrier 30 is intact and the red light 84 indicates that the integrity of the safety barrier 30 is or may be compromised. The post 10 also includes a siren 86 to sound an audible alarm when the red light 84 is on. The safety barrier 30 can use a low voltage electrical current ensuring a continuous flow of power until one or several of the parts are hit or temporarily removed. The low voltage can be for instance 12 Volts or less. The alarm system 80 includes a subsystem detecting if a low voltage electrical current is interrupted between two points in the safety barrier 30 and trigger an alarm signal when detecting an interruption. When the alarm signal is triggered, the red light 84 is activated and the siren 86 sounds an alarm. This alarm can also be communicated to a central unit and/or to a maintenance/safety crew. Variants are also possible.

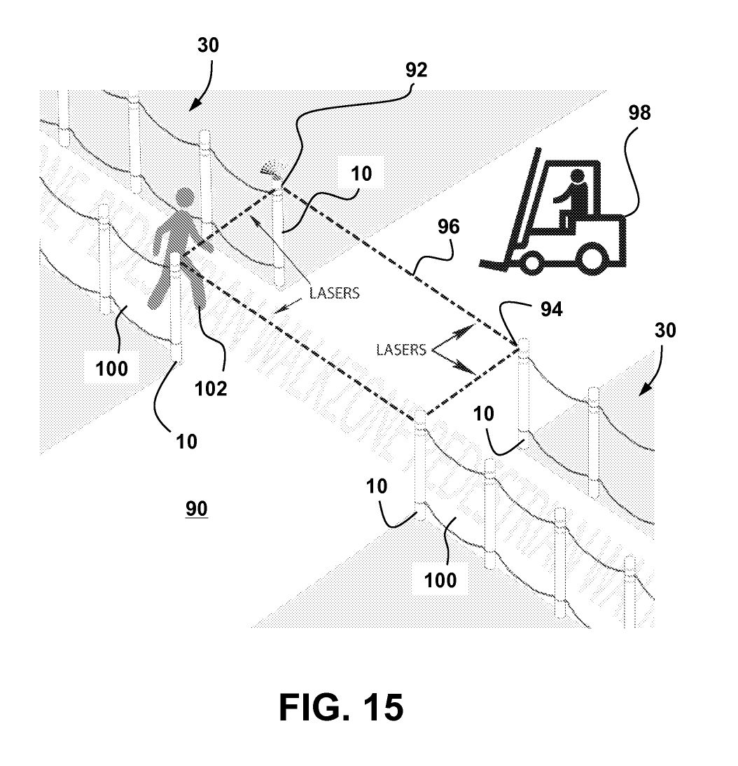

FIGS. 15 to 19 are semi-schematic views illustrating examples of optical sensor arrangements provided at locations where a roadway and a pedestrian walkway overlap with one another.

FIG. 15 is a semi-schematic view illustrating an example of an optical sensor arrangement extending between two spaced-apart portions of the safety barrier 30. No interconnecting segment 32 is present between the posts 10 of the first portion and the posts 10 of the second portion since the safety barrier 30 crosses a roadway 90. Pairs of first and second optical sensors 92, 94 are provided. For instance, a first optical sensor portion 92 is provided on the post 10 of the first safety barrier portion and a second optical sensor portion 94 is provided on the opposite post 10. The first optical sensor portion 92 can be for instance a laser beam projector creating a laser beam 96 and the second optical sensor portion 94 can be for instance a laser beam receiver. This configuration is repeated on the other side. This arrangement will sound an alarm when an object or person crosses one of the laser beams 96 and blocks the light at the corresponding receiver 94. The alarm will indicate either the presence of a vehicle 98 crossing the walkway 100 or a pedestrian 102 going over the roadway 90. Variants are possible as well. For instance, a control system can be provided to sense the pedestrian 102 crossing a first one of the laser beams 96 as he or she enters the common zone between the roadway and the walkway 100, and only sound an alarm if the pedestrian 102 crosses one of the laser beams 96 on the side, indicating that the pedestrian 102 is now on the roadway 90 and out of the walkway 100.

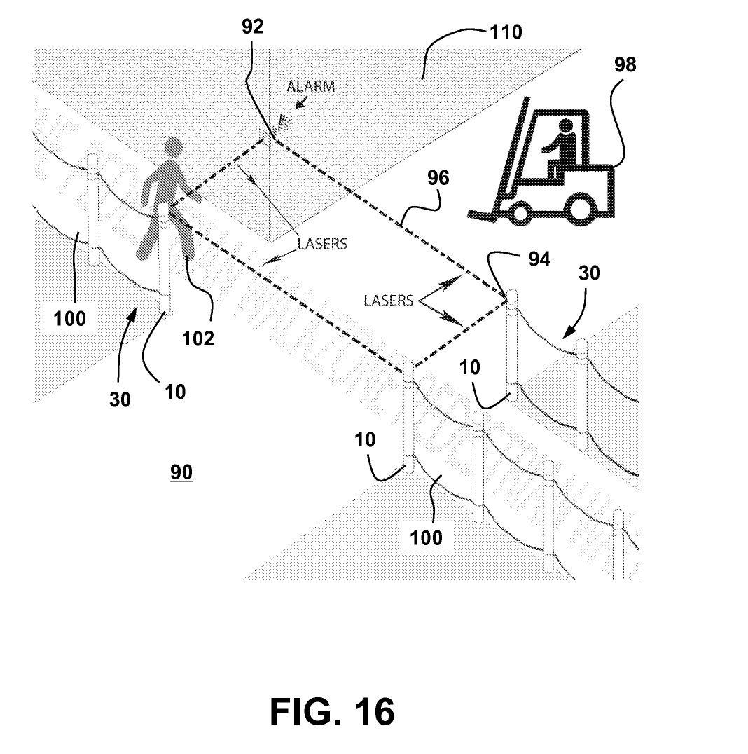

FIG. 16 is a semi-schematic view illustrating another example of an optical sensor arrangement extending between two spaced-apart portions of the safety barrier 30. This arrangement is similar to the one shown in FIG. 15, which the exception that one of the portions of the safety barrier 30 is provided next to a wall 110. Some of the parts of the optical sensor arrangement, for instance the first optical sensor portion 92, are mounted on the wall 110. Other parts can be provided on the wall 110 as well.

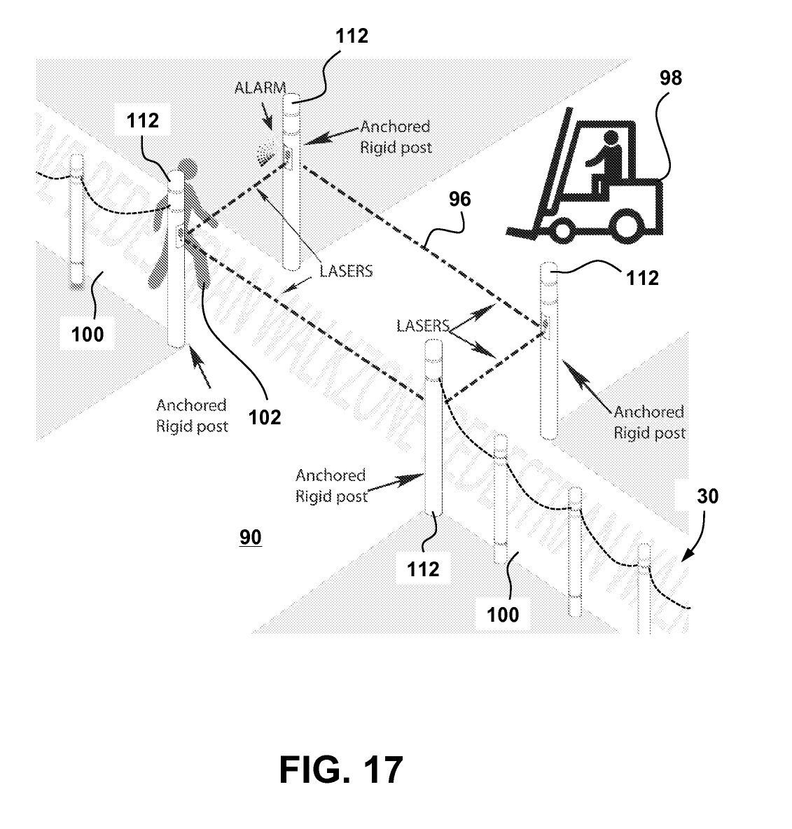

FIG. 17 is a semi-schematic view illustrating another example of an optical sensor arrangement. In this example, the optical sensor portions are mounted on spaced-apart anchored rigid posts 112, one being provided at each corner of the overlapping zone.

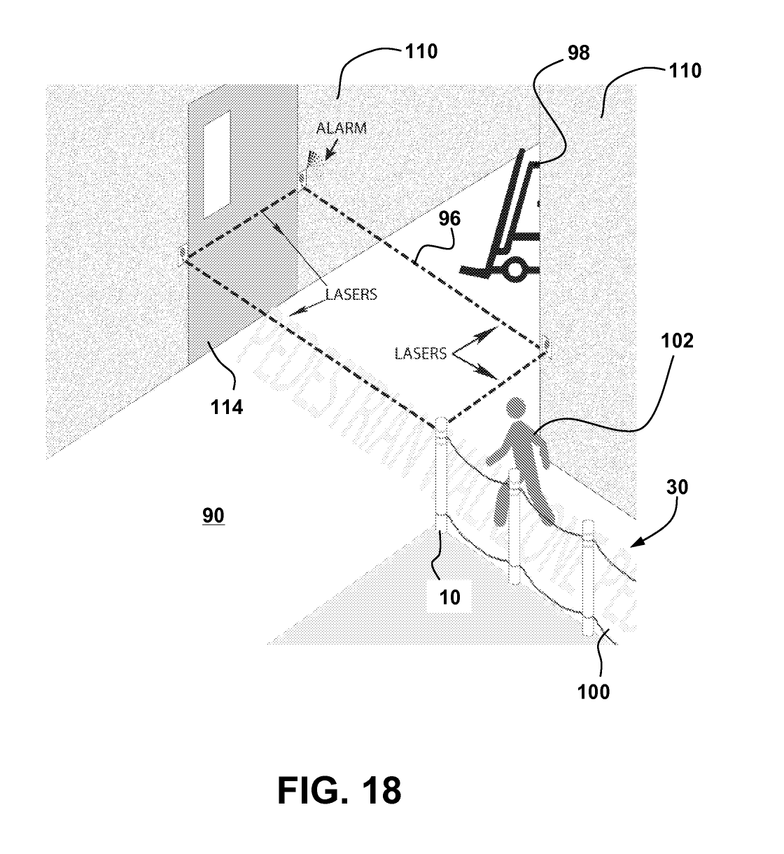

FIG. 18 is a semi-schematic view illustrating another example of an optical sensor arrangement. In this example, the optical sensor portions are mounted on one of the posts 10 of the safety barrier 30 and also on walls 110. One of the walls 110 includes a door 114.

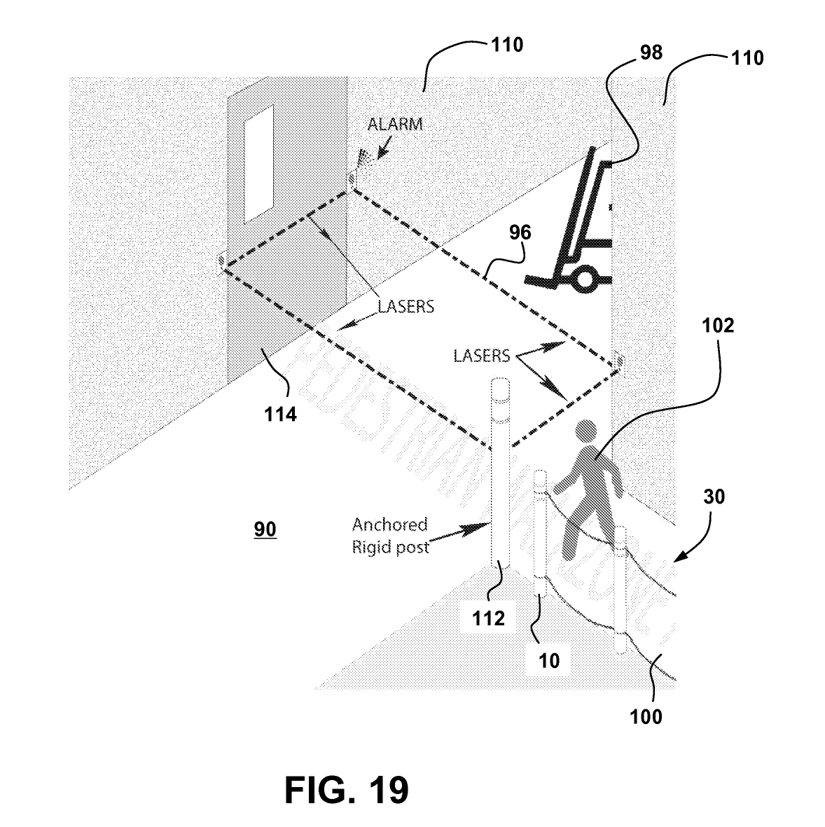

FIG. 19 is a semi-schematic view similar to FIG. 18 but where some of the optical sensor portions are mounted on an anchored rigid post 112 instead of being mounted on one of the posts 10 of the safety barrier 30. This can be the case, for instance, of an installation where the anchored rigid post 112 was already present before the safety barrier 30 was installed.

The present detailed description and the appended figures are meant to be exemplary only, and a skilled person will recognize that many changes can be made while still remaining within the proposed concept. For instance, posts are not necessary shaped as illustrated and can have other shapes and/or cross sections. The interconnecting segments are not limited to chains and screen-like panels. They can be ropes, wires, bars, etc. A safety barrier can include more than one kind of interconnecting segments, even in the same intervening space between two successive posts. Although various examples of arrangements for releasibly connecting the bottom portion of the posts to the floor surface have been present, other arrangements can be devised. When permanent magnets are used, each magnet can be made of a single magnetic piece or a plurality of magnetic pieces grouped together. Still, many other variants of the proposed concept will be apparent to a skilled person, in light of a review of the present disclosure.

What is claimed is:

1. A safety barrier for delimiting two adjacent areas from one another on an open floor surface, the safety barrier including:
a plurality of spaced-apart posts, each post having a bottom portion releasibly connectable to the floor surface and having a vertically-extending upper portion; and
at least one interconnecting segment located above the floor surface and transversally extending across a corresponding intervening space between each two successive ones of the spaced-apart posts, each interconnecting segment having opposed ends connected to the upper portion of the two corresponding posts;
wherein, in use, when one of the posts and/or one of the interconnecting segments is/are subjected to an impact with a moving object, the connection between the impacted post and the floor surface and/or the connection between the impacted post and any interconnecting segment connected thereto and/or the connection between the impacted interconnecting segment and any one of the posts to which it is connected can be temporally discontinued.

2. The safety barrier as defined in claim 1, wherein at least one of the ends of the least one interconnecting segment is releasibly connected to the upper portion of the corresponding post.

3. The safety barrier as defined in claim 2, wherein the at least one end of the least one interconnecting segment is releasibly connected to the upper portion of the corresponding post by a magnet.

4. The safety barrier as defined in claim 1, wherein the bottom portion of each post is releasibly connectable to the floor surface using a magnetic force provided a permanent magnet.

5. The safety barrier as defined in claim 4, wherein the permanent magnet is located within a recess in the bottom portion of each post.

6. The safety barrier as defined in claim 5, wherein the permanent magnet is magnetically coupled to a plate rigidly anchored to the floor surface.

7. The safety barrier as defined in claim 4, wherein the bottom portion of each post includes a protective outer ring.

8. The safety barrier as defined in claim 7, wherein the protective outer ring is made of a polymeric material, such as rubber or another relatively soft material.

9. The safety barrier as defined in claim 1, wherein the bottom portion of each post is releasibly connectable to the floor surface using a removable snap-fit engagement between a recess in the bottom portion of each post and a corresponding floor surface member.

10. The safety barrier as defined in claim 1, wherein the bottom portion of each post is releasibly connectable to the floor surface using a suction arrangement.

11. The safety barrier as defined in claim 1, wherein the bottom portion of each post is releasibly connectable to the floor surface using a recoil device located inside each post, the recoil device pulling back a wire or a rope having its free end attached to the floor surface.

12. The safety barrier as defined in claim 11, wherein the free end of the wire or rope is removably attached to a plate that is rigidly anchored to the floor surface.

13. The safety barrier as defined in claim 1, wherein the bottom portion of each post is releasibly connectable to the floor surface using an elastic band having a top end attached inside each post and a bottom end attached to the floor surface.

14. The safety barrier as defined in claim 13, wherein the bottom end of the elastic band is removably attached to a plate that is rigidly anchored to the floor surface.

15. The safety barrier as defined in claim 14, wherein the bottom portion of each post includes a protective outer ring.

16. The safety barrier as defined in claim 15, wherein the protective outer ring is made of a polymeric material, such as rubber or another relatively soft material.

17. The safety barrier as defined in claim 1, further including an alarm system that detects if one or more ends of the interconnecting segments are detached and/or that detects if one or more posts are tilted.

18. The safety barrier as defined in claim 17, wherein the alarm system includes a subsystem designed to trigger a visual and/or audible alarm upon detecting that one or more ends of the interconnecting segments are detached and/or upon detecting that one or more posts are tilted.

19. The safety barrier as defined in claim 18, wherein the alarm system includes a subsystem detecting if a low voltage electrical current is interrupted between two points in the safety barrier and trigger an alarm signal when detecting an interruption.

20. The safety barrier as defined in claim 1, further including at least one optical sensor arrangement extending between two spaced-apart portions of the safety barrier.

21. A method of delimiting two adjacent areas from one another on an open floor surface, the method including:
releasibly connecting a plurality of spaced-apart posts to the floor surface, each post having a bottom portion to the floor surface and having a vertically-extending upper portion;
providing at least one interconnecting segment located above the floor surface and transversally extending across a corresponding intervening space between each two successive ones of the plurality of spaced-apart posts, each interconnecting segment having opposed ends connected to the upper portion of the two corresponding posts; and
allowing one of the posts and/or one of the ends of the interconnecting segments to be removably discontinued when subjected to an impact with a moving object.
